(19) United States
(12) Patent Application Publication
(10) Pub. No.: US 2022/0305307 A1
(43) Pub. Date: Sep. 29, 2022

(54) SELF-ADJUSTING SAFETY HARNESS

(71) Applicant: Pigeon Mountain Industries, Inc., LaFayette, GA (US)

(72) Inventors: Lois MCCURLEY, Bennett, CO (US); Robert MCCURLEY, Bennett, CO (US)

(73) Assignee: Pigeon Mountain Industries, Inc., LaFayette, GA (US)

(21) Appl. No.: 17/703,117

(22) Filed: Mar. 24, 2022

Related U.S. Application Data
(60) Provisional application No. 63/165,348, filed on Mar. 24, 2021.

(51) Int. Cl. A62B 35/00

(52) U.S. Cl. CPC A62B 35/0018; A62B 35/0025

(57) ABSTRACT

A leg strap of a safety harness has a first end with a movement-permitting connector, a second end attached to an upper portion of the harness, and an intermediate portion formed into a loop and slidably extending through the connector. The leg strap thereby forms a leg loop portion and a tensioning riser portion each having a variable length, so that in use when wearers reposition themselves the portion of the leg strap forming the leg loop is automatically adjusted for comfort. Some embodiments include seat panels with bottom portions forming a segment of the leg straps and leg loops.

### CROSS-REFERENCE TO RELATED APPLICATION

This application claims the priority benefit of U.S. Provisional Patent Application Ser. No. 63/165,348 filed Mar. 24, 2021, which is hereby incorporated by reference herein for all purposes.

### TECHNICAL FIELD

The present invention relates generally to safety equipment for working at elevated heights, and particularly to personal safety suspension harnesses.

### BACKGROUND

Safety harnesses are used for suspending persons in positions elevated above ground to perform a variety of tasks, for example cleaning windows, inspecting bridges, maintaining wind turbines, and rescuing others. Conventional safety harnesses have leg loops that surround and support the wearer's legs and are adjustable to fixed positions with a fixed circumference for use. Drawbacks to these conventional harnesses include that they do not provide an optimum seated position for work comfort. Also, the fixed leg loops are constrictive and tend to pull up during use, thereby compressing the crotch region of the wearer and causing discomfort and pain.

Accordingly, it can be seen that needs exist for improvements in safety harnesses that are more comfortable for the wearer during use. It is to the provision of solutions to this and other problems that the present invention is primarily directed.

### SUMMARY

Generally described, the present invention relates to safety harnesses including two leg straps, each having a first end with a movement-permitting connector (e.g., a slot ring), a second end attached to an upper portion of the harness (e.g., a waist belt), and an intermediate portion formed into a loop and slidably extending through the connector. The leg strap thereby forms a leg loop portion and a tensioning riser portion each having a variable length, so that in use when wearers reposition themselves the portion of the leg strap forming the leg loop is automatically adjusted for comfort. Some embodiments include seat panels with bottom portions forming a segment/portion of the leg straps and leg loops. Various embodiments include the self-adjusting leg loops with the seat panels, the self-adjusting leg loops but not the seat panels, and the seat panels but not the self-adjusting leg loops.

The specific techniques and structures employed to improve over the drawbacks of the prior art and accomplish the advantages described herein will become apparent from the following detailed description of example embodiments and the appended drawings and claims.

### BRIEF DESCRIPTION OF THE DRAWINGS

FIG. 1 is a front perspective view of a safety harness according to a first example embodiment, showing the safety harness in use in an upright-positioning configuration suspending a wearer in a relatively upright position.

FIG. 2 is a rear perspective view of the safety harness of FIG. 1, showing the safety harness in use in a reclined-positioning configuration suspending a wearer in a relatively reclined position.

FIG. 3 is a rear view of the safety harness of FIG. 1 on a standing wearer.

FIG. 4 shows a front view of the safety harness of FIG. 3.

FIG. 5 is a schematic view of a portion of the safety harness of FIG. 1, showing a self-adjustment features of one of the leg loops.

FIG. 6 is a perspective view of a seat plate of the safety harness of FIG. 1.

FIG. 7 is a perspective view of the portion of the safety harness of FIG. 5.

FIG. 8 is a side view of the safety harness of FIG. 1, showing the safety harness in a loose configuration (pre-adjusted relatively longer/looser) on a standing wearer.

FIG. 9 shows the safety harness of FIG. 8 in a loose configuration (pre-adjusted relatively shorter/tighter) on the standing wearer.

FIG. 10 is a side view of a safety harness according to a second example embodiment, showing the safety harness in a loose configuration on a standing wearer.

### DETAILED DESCRIPTION OF EXAMPLE EMBODIMENTS

Generally described, the present invention relates to a safety harness with self-adjusting leg loops that are self-equalizing in length and transmission of force. The safety harness can be of a conventional suspension type used for suspending persons in positions elevated above ground to perform various tasks. For example, the safety harness can be a full-body harness (including a seat harness and a shoulder harness, as described herein) or a seat harness (without a shoulder harness). The self-adjusting leg loops can be implemented/embodied in any safety harness having leg loops and an upper (e.g., waist, torso, and/or shoulder) portion.

The safety harness includes an upper portion and leg straps with movement-permitting connecters forming two self-adjusting leg loops. The second end of each leg strap is connected to the harness upper portion. The movement-permitting connecter is attached to the first/other end of the leg strap. And an intermediate portion of the leg strap (between the first and second ends) is routed and slides through the movement-permitting connecter. Thus, the portion of each leg strap between the first end (where it is connected to the connector) and an intermediate location (where it is slidable through the connector) is wrapped around the wearer's leg to form a supporting leg loop. And the portion of each leg strap between there and the other/second end functions as a tensioning riser.

In the depicted embodiments, the harness upper portion includes a waist belt to which the second end of each leg strap attaches. In other embodiments, the harness upper portion includes shoulder straps, torso straps, or other straps, panels, or supports to which the second end of each leg strap attaches.

Also in the depicted embodiments, the harness includes seat panels that form a portion of the leg loops, with the leg straps having a first segment (integrated into, attached to, or defined by the seat panel) forming a first (e.g., rear) portion of each leg loop and a second segment forming a second (e.g., front) portion of each leg loop and extending through the connector to define the tensioning riser. In other embodiments (e.g., without seat panels), the leg strap is one continuous length from the first end and connector, to the intermediate portion slidably routed through the connector, to the second end.

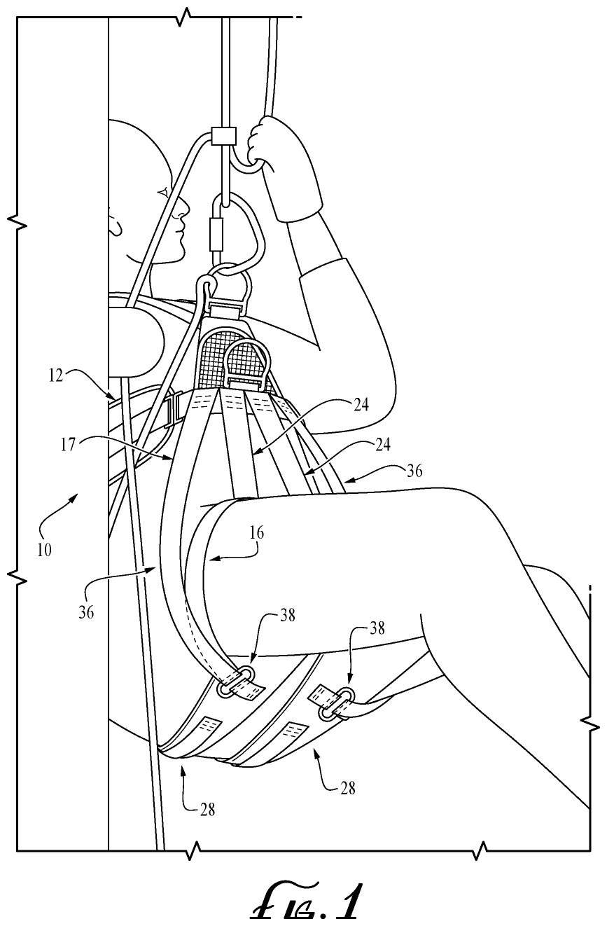

FIGS. 1-9 show a safety harness 10 according to a first example embodiment. The safety harness 10 includes a waist belt 12, two shoulder straps 14 connected to the waist belt 12, and two leg loops 16 formed by two leg straps 36 connected to the waist belt 12 or another part of the harness. The connections of the shoulder straps 14 and the leg straps 36 to the waist belt 12 can be by conventional strap attachments for safety harnesses, for example buckles (for strap adjustability), stitching (for fixed/non-adjustable attachments), D-rings, O-rings, clips, or other strap attachments used for safety harnesses. The shoulder straps 14 and leg straps 36 can be provided by conventional nylon webbing, other strap materials used for safety harnesses, or other cord or other materials used for safety harnesses.

The waist belt 12 extends around the waist of the wearer to provide a snug fit. In the depicted embodiment, the waist belt 12 includes a waist strap 11 and a padded panel 13. The waist strap 11 provides structural strength and is where the shoulder straps 14 and leg straps 36 typically attach. The waist strap 11 can be provided in one continuous length or in multiple segments connected together, for example one shorter front unpadded waist strap segment 11 and one longer rear/side waist segment 11 (padded by the padded panel), as depicted. The padded panel 13 is attached to the waist strap 11 and positioned on the inner surface (e.g., the rear/side) of at least a portion of the waist strap 11 for wearer comfort. Also, the waist belt 12 typically includes rings or other attachments 15 for holding tools (e.g., for use by the wearer when suspended at heights). In other embodiments, the waist belt can have other configurations used for safety harnesses.

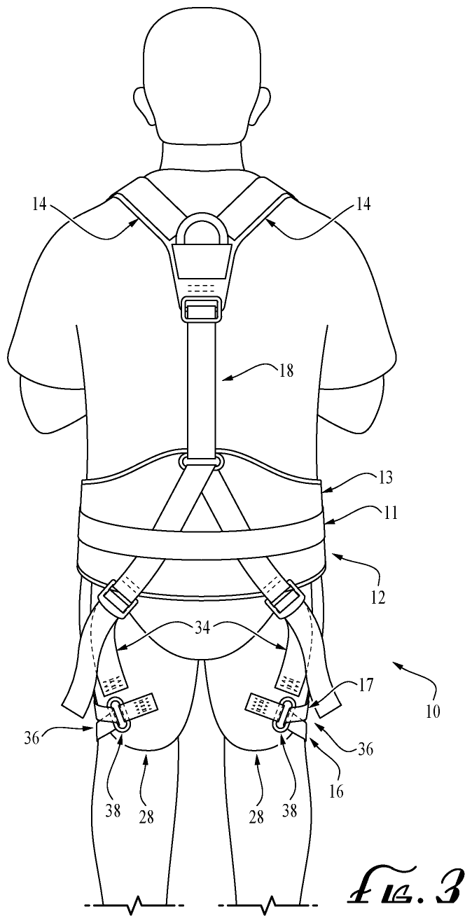

The shoulder straps 14 extend over the wearer's shoulders and (directly or indirectly) attach to front and rear portions of the circumferential waist belt 12. In the depicted embodiment, the shoulder straps 14 attach to a rear portion of the waist belt 12 by a connecter strap 18 that is positioned between the rear free ends of the shoulder straps 14 and the rear-center portion of the waist belt 12, as shown in FIG. 3. As such, the depicted shoulder straps 14 attach indirectly to a rear portion of the waist belt 12. In other embodiments, the shoulder straps attach directly to a rear portion of the waist belt.

Also, the shoulder straps 14 can attach to a front portion of the waist belt 12 by a three-way connection 20 that is positioned between the front free ends of the shoulder straps 14 and free ends of the waist belt 12, as depicted in FIG. 4. The three-way connection 20 can include the horizontal front waist strap segment 11 extending between the free ends of the rear/side waist strap segment 11 of the waist belt 12 for structural strength and to complete the circumference around the wearer's waist. And the three-way connection 20 can include two upright (e.g., slightly angled) torso straps extending between the shoulder straps 14 and the ends of the front waist strap segment 11 for structural strength so that these three straps form a triangular shape (and so the three-way connection 20 is triangular shaped), as depicted. The front waist strap segment 11 (positioned between and connecting together the free ends of the side/rear waist strap segment 11 of the waist belt 12) is a part of the three-way connection 20, and thus functions as and is a structural strength a part of the waist belt 12 and the three-way connection 20. As such, the shoulder straps 14 of the depicted embodiment attach indirectly to the front of the waist belt 12. In other embodiments, the shoulder straps attach directly to the front of the waist belt.

The shoulder straps 14 can be adjustable, for example they can include conventional adjustment buckles as the attachments to the connecter strap 18 and/or to the three-way connection 20, as depicted. One or more conventional attachments (e.g., D-rings) 22 for connecting a safety tether (e.g., rope, cable, etc.) can be provided on the three-way connection 18 (as depicted) and/or elsewhere on the harness 10. The safety tether is the life line suspending the wearer at the elevated height.

The self-adjusting feature of the safety harnesses 10 is implemented in the leg loops 16. Each leg loop 16 is formed by a looped portion of each leg strap 36 that wraps around one of the wearer's legs. The leg straps 36 each have a first end 41, a second end 42, and an intermediate portion between them, with the second end 42 attached to the waist belt 12, and with the rest of the leg strap 36 (other than the leg loop 16) forming a riser tensioning portion 17. These features are described in more detail below.

The self-adjusting leg loops 16 are typically also attached to the waist belt 12 by one or more support risers to support the leg loops 16 at a maximum distance/drop from the waist belt 12. In the depicted embodiment, for example, the leg loops 16 are additionally attached to the waist belt 12 by front support risers 24 and rear support risers 26. In other embodiments, the leg loops are additionally attached to the waist belt by front support risers (without no rear support risers included) or by rear support risers (without no front support risers included). And other embodiments do not include any additional support risers or other attachments of the leg loops to the waist belt, so the leg loops are attached to the rest of the harness only by the second ends of the leg straps.

The front support risers 24 can be of a conventional type, for example straps (e.g., webbing) that fixedly or adjustably attach to the front portion of the waist belt 12. The front support risers 24 can be attached to the front portion of the waist belt 12 for example at the three-way connection 20.

The rear support risers 26 of the depicted embodiment include seat panels 28 and rear riser straps 34. The seat panels 28 distribute the load of the wearer's weight during use for increased comfort. Each seat panel 28 forms one half of a seat for the wearer during use.

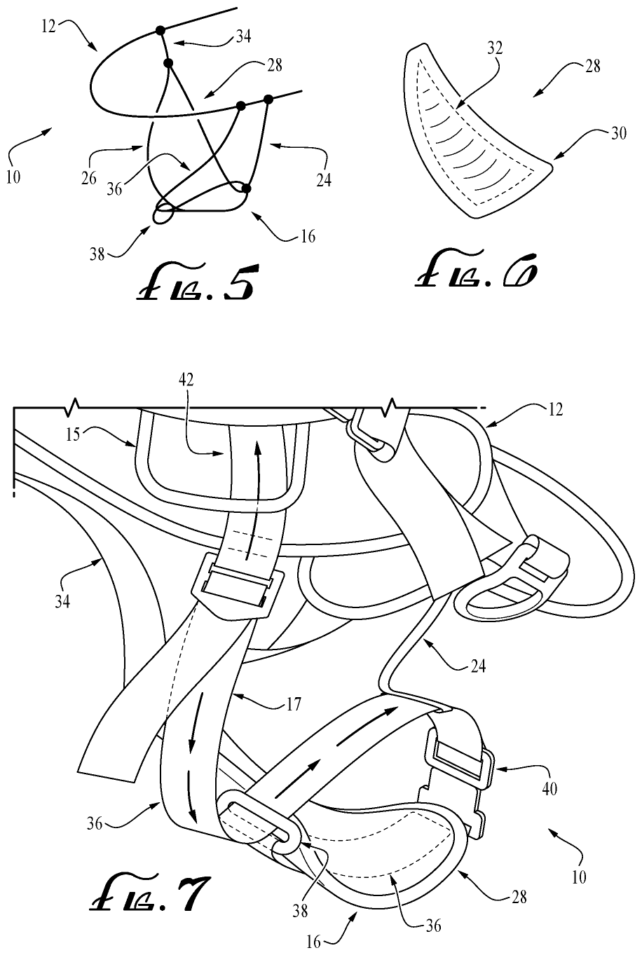

In the depicted embodiment, the seat panels 28 are generally elongated and in the form of generally flat shells 30 holding generally flat and rigid plates 32 having a conforming shape and size, as shown in FIG. 6. The seat plates 32 are rigid such that they maintain their shape, with only nominal or negligible deformation not affecting the intended use, when an adult of at least average weight is wearing the harness 10 and seated on the seat panels 28 while suspended during use. As such, the seat plates 32 can be made of materials such as hard plastic or metal. The seat panels 28 form a substantial portion of the length of the rear risers 26, with the rigidity and length of the seat plates 32 helping hold the leg loops 16 in place during use so that the force of the seated wearer is transmitted longitudinally along the back of the thigh, as supported by the seat plates. With forces thus distributed, the leg straps 36 and seat panels 28 work together to lift the knees and thighs of the user into a seated position rather than pulling the leg straps 36 up into the wearer's crotch region.

Also, the leg loops 16 each extend horizontally all the way around the respective leg at a uniform drop distance below the waist and crotch of the wearer, with the leg loops 16 around the upper thighs below the wearer's crotch, with the leg loops 16 not angled from the crotch to the waist of the wearer, and with the support risers 24 and 34 defining the drop distance. The rigid elongated seat panels 28 thus provide mechanical interference (blocking/spacing functionality) to restrain the leg loops 16 from being pulled up into the wearer's crotch during use.

In the depicted embodiment. the seat panels 28 are generally elongated and generally triangular, with the seat shells 30 housed seat plates 32 having a conforming shape and size, as shown in FIG. 6. The seat plates 32 typically have a curved shape to cradle (and somewhat conform to) the human buttocks of the wearer. The seat-plate curvature in embodiments for wearers with narrower hips is typically different (e.g., greater) from that in embodiments for those with wider hips. The seat shell 30 can include a padding on the inner half that is between the plate 32 and the wearer during use. In other embodiments, the seat panels include seat plates with integral padding on their inner surface (against the wearer), with the seat plates attached to other parts of the harness (e.g., the leg and rear riser straps), and without the seat shells.

The top of the seat panels 28 (e.g., the top/apex corner of the depicted generally triangular and elongated seat panels 28) is attached to the waist belt 12, for example indirectly by the rear riser strap 34 and attachment (e.g., adjustment buckle), as depicted, or directly (with or without a rear riser strap and/or adjustment attachment). The bottom portion of the elongated triangular seat panel 26 (between the two bottom/base corners) extends laterally across the back side of the wearer's buttocks and/or upper thighs, and typically includes a first leg strap segment (shown in phantom lines in FIG. 7) that is a segment of the leg strap 36 and that forms a rear portion of the leg loop 16, as described in more detail below. As used herein, the first leg strap segment means the bottom transverse/lateral portion of the seat panel 26 (between its bottom corners) that functions as the rear portion of the leg loop 16, regardless of whether a conventional strap is actually included or not.

The seat panels 28 need not be strictly/literally triangular, but typically they have a generally triangular shape, for example with the three corners rounded or flattened at the top/apex corner (where the rear riser strap attaches) and/or the bottom/base corners (where the connector and second leg strap segment attach). Also, the seat panels 28 can be non-symmetrically triangular, with the bottom/base portions positioned at the inner thighs being extended laterally more so than at the outer thighs of the wearer. In other embodiments, the seat panels have another shape such as elliptical, rectangular, or polygonal. In yet other embodiments, the rear support risers each include a rear riser strap that extends all the way between the waist belt and the respective leg loop, and as such do not include a seat panel.

Continuing with the self-adjusting leg loops 16, a movement-permitting connector 38 is attached to the first end 41 of each leg strap 36. In the depicted embodiment, each leg strap 36 includes two segments. The first leg strap segment 36 is attached to or integrated into the bottom portion of the seat panel 28 (extending between the two (inner thigh and outer thigh) bottom/base corners of the seat panel 28). For example, the first leg strap segment 36 can be positioned inside and stitched to the bottom portion of the seat panel 28, as depicted in FIG. 7. So the connector 38 attached to the first end 41 of each leg strap 36 is also attached to/at the outer-thigh bottom/base corner of the seat panel 28. And the second leg strap segment 36 (the part of the leg strap 36 not integrated into or attached to the seat panel 28) has its first end 40 attached to the inner-thigh bottom/base corner of the seat panel 28, with the intermediate portion slidably routed through the connector 38. The second leg strap segment 36 is the portion of the leg strap 36 that attaches to the waist belt 12, so the second end 42 of the second leg strap segment 36 is the same thing as the second end 42 of the leg strap 36.

As such, in the depicted embodiment, the leg loops 16 are formed by the combination of the first leg strap segments 36 (the bottom/base portions of the seat panels 28, which form the first/rear portions of the leg loops 16) and the second leg strap segments 36 (the non-seat-panel portions of the leg straps before the connectors 38, which form the second/front portions of the leg loops 16). Thus, the self-adjusting feature of the safety harness 10 fully integrates the seat panels 28 into the leg loops 16 by way of the leg straps 36. In other embodiments, the seat panels are not included, and the leg loops are each provided by one continuous strap extending all the way around the wearer's leg (instead of the depicted first and second leg strap segments 36 together forming each leg loop).

The movement-permitting connector 38 movably engages the leg strap 36 to permit the leg strap 36 to move (e.g., slide or roll) longitudinally along its axial/length direction but constrains it from moving laterally in a direction transverse to its axial/length direction. For example, the movement-permitting connector 38 can be provided by a slot ring (as depicted), D-ring, or eyelet (for sliding movement), by a roller or a pulley (for rolling movement), or by another connector that permits the longitudinal movement and prevents the transverse detachment of the leg strap 36, as described herein. The movement-permitting connector 38 can be attached to the bottom outer (closest to the wearer's outer thigh) corner of the seat panel 28 of the rear riser 26 (as depicted), which also defines the first end 41 of the leg strap 36.

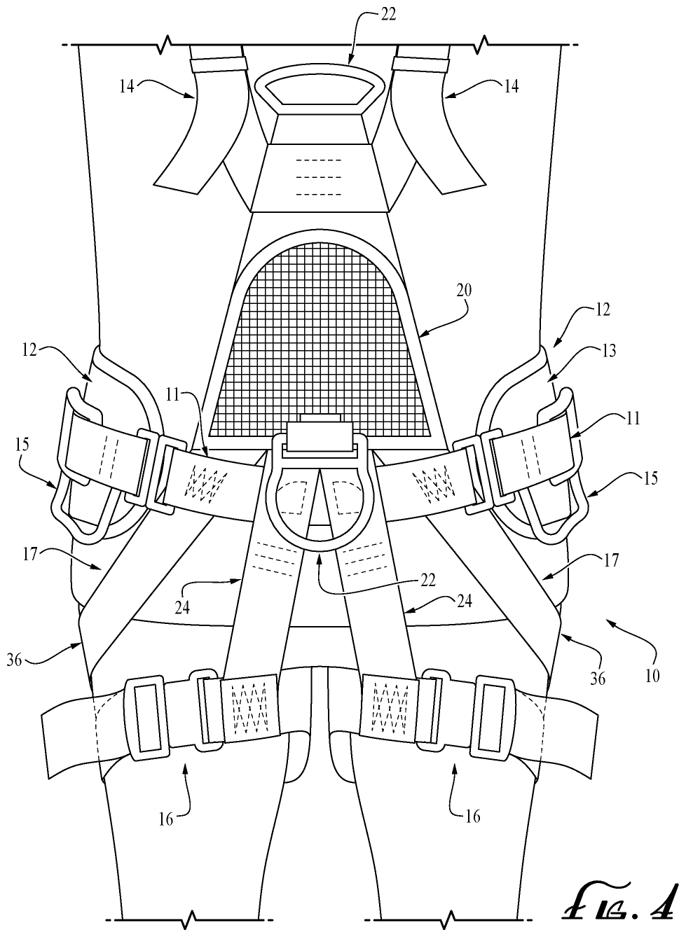

The self-adjusting leg-loop feature can be best seen in FIGS. 5 and 7. Each leg strap 36 has a first end 41 with the connector 38, a second end 42 attached to an upper portion of the harness (e.g., the waist belt 12), and intermediate portion that is slidably routed through the connector 38. The leg loop 16 is the current portion of the leg strap 36 that is wrapped laterally around the wearer's leg (between the first end 41 and the location on the strap where it extends through the connector 38). In the depicted embodiment, the leg loop 16 includes two portions, the first (e.g., rear) portion (the bottom/base portion of the seat panel 28, which forms the first leg strap segment 36) and the second (e.g., front) portion (the then-current portion of the second leg strap second before the connector 38). And the tensioning riser 17 is the then-current portion of the leg strap 36 that is not wrapped around the wearer's leg (it's between the second end 42 and the location on the strap where it extends through the connector 38).

Accordingly, each leg strap 36 extends around the wearer's respective leg, is slidably routed through the respective movement-permitting connector 38, and extends upward and attaches to the waist belt 12 (as depicted) or another part of the safety harness 10 (e.g., an upper portion at or above the wearer's waist). So the two portions of the leg strap 36 that form the leg loop 16 and the tensioning riser 17 (with the connector 38 delineating the difference) are variable and different at any given moment in time depending on the how much of the intermediate portion of the leg strap 36 is on which side of the connector 38. Thus, when the leg loop 16 has a greater circumferential length, the tensioning riser 17 has a shorter length, and vice versa. This results in a floating connection that enables the leg loops 16 to self-adjust based on movement of the wearer in the harness 10. As such, with the leg loops 16 donned and pre-adjusted for the particular wearer, in suspension use they are not static, but rather they are dynamically self-adjustable, with the leg straps 36 sliding or otherwise moving through/around the connectors 38 to make the leg loops 16 have a smaller or larger circumferential length.

The first end 40 of the first leg strap segment 36 can be securely but adjustably and removably attached to the seat panel 26, for example by an adjustable buckle or other attachment, with the front riser 24 attached to or adjacent the attachment (see also FIG. 4). The second opposite end 42 of the leg strap 36 can be fixedly attached to the waist belt 12, for example by stitching or another attachment (see also FIG. 4). In other embodiments, the adjustable attachment for the leg strap 36 attaches its second end 42 to the waist belt.

It will be understood that when referring to the ends of the leg strap, this means the functional ends of the strap for the purposes of forming the leg loop and the tensioning riser for self-adjustment, and is not limited to the physical/terminal end of the strap and/or the location of an adjustment buckle. In some embodiments, the leg straps extend beyond the “ends” for other purposes, and embodiments with the leg straps not terminating at the ends (as defined herein) are contemplated by and within the scope of the claimed invention.

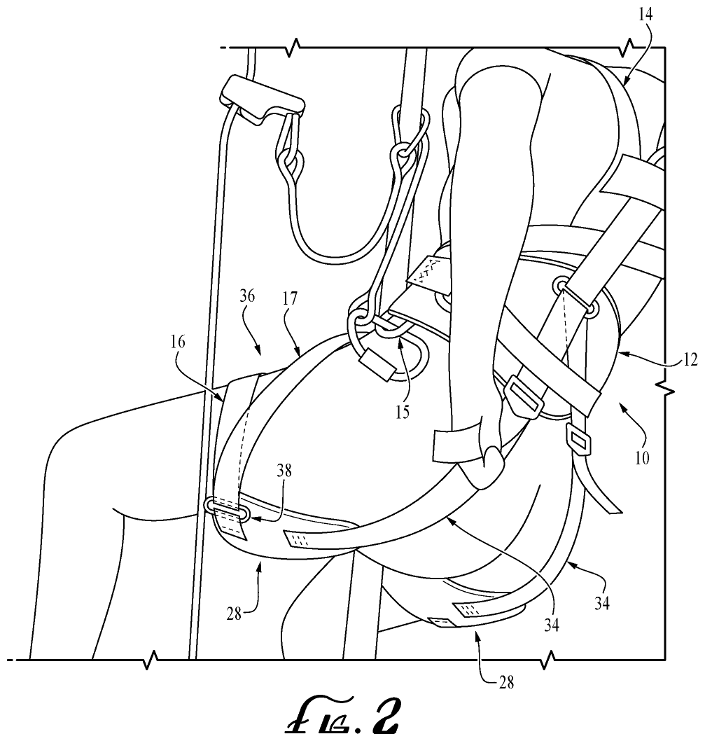

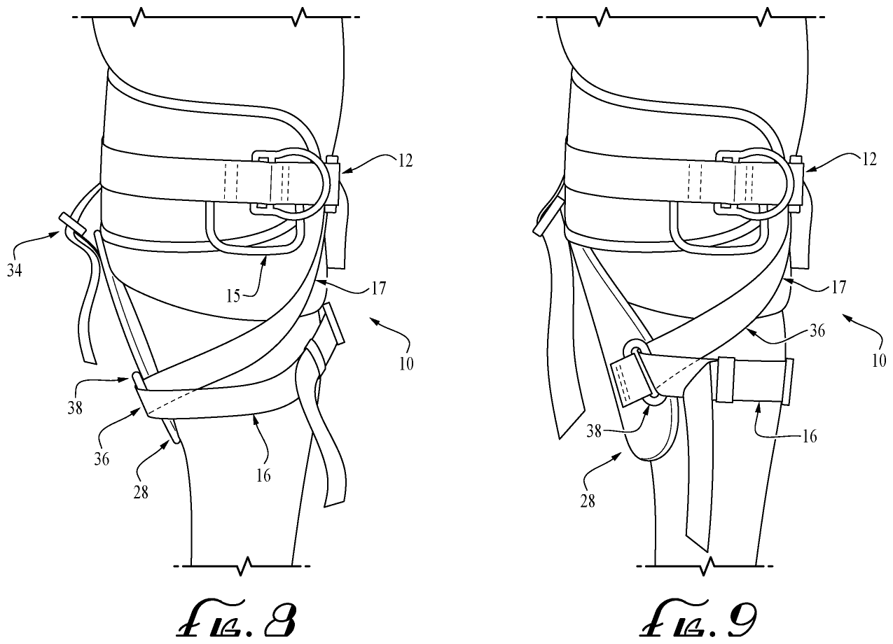

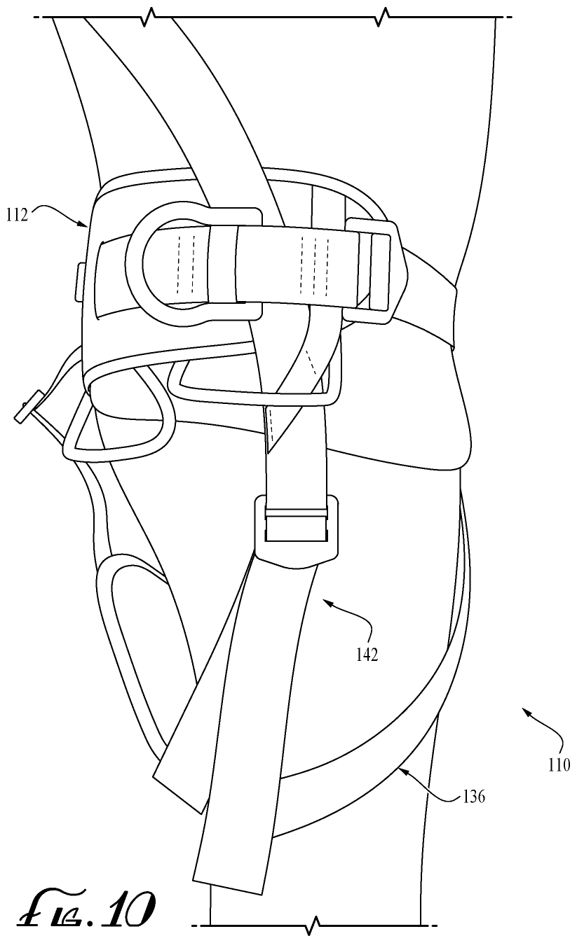

In use, the self-adjusting feature enables the leg loops 16 to self-adjust (i.e., self-equalize) in girth (loop circumference) and seat height (seat panel elevation and angle) based on movement of the wearer's body. The integration of the seat panels 28 with the leg straps 28, and their respective direction of pull from the upper portion of the harness, pulls the wearer into a relatively upright position. For example, when the wearer shifts their weight forward in the harness 10, pushing backward with their buttocks in the harness 10, the harness 10 pulls the wearer into a relatively upright position, as shown in FIG. 1. From there, when the wearer leans backward at the waist, the leg loops 16 self-adjust (i.e., reposition by the leg straps 36 sliding through the connectors 38), because this applies tension on the leg straps 36 (on the tensioning riser portion of the leg straps 36) and thereby pulls a greater length of the leg straps 36 upward past the connectors 38. This in turn pulls on and lifts the bottom portion of the seat panels 28 to raise the wearer's legs into a cradled position, as shown in FIG. 2. This also slightly tightens the leg loops 16 around the wearer's legs, but particularly in embodiments with the rigid elongated seat panels 28, the leg loop portions 16 of the leg straps 36 cannot pull up into the wearer's crotch. When the wearer straightens their torso in the harness 10, such as when climbing or ascending rope, the leg loops 16 self-adjust to cause the leg loop 16 to loosen around and lower the legs back into the normal upright position. And when the wearer disconnects from the safety tether and stands on the ground, the leg loops 16 self-adjust to cause the leg loop 16 to further loosen around and lower the legs back so that the harness 10 is more comfortable to walk around in, as shown in FIGS. 8 and 9.

Also, the leg loops 16 can be manually pre-adjusted between lower and upper positions on the wearer before use, then manually adjusted again as needed while under tension, and then during use self-adjusted (automatically adjusted as wearers reposition themselves) as described above. For example, the attachments (e.g., buckles and straps) for the front risers 24 and/or the rear risers 26, and/or for the leg strap 36, can be pre-adjusted longer as in FIG. 8 or shorter as in FIG. 9.

FIG. 10 shows a safety harness 110 according to a second example embodiment. The safety harness 110 is substantially the same as that of the first embodiment, except that the leg straps 136 each attach to the waist belt 112 at side portions (instead of front portions) of the waist belt 112 to create a different angle of the strap pulling force for a different body type. Also, the adjustable attachments for the leg straps 136 adjustably attach the second ends 142 of the leg straps 136 to the waist belt 112 (instead of adjustably attaching the first ends of the leg straps to the waist belt). The safety harness 110 of this embodiment is designed for wearing use by persons with larger hips and buttocks (e.g., many females and others with relatively more curvaceous body types), whereas the safety harness 10 of the first embodiment is designed for wearing use by persons with a narrower, straighter hip and buttock profile (e.g., many men and others with relatively less curvaceous body types).

In other embodiments, the rear risers each include a respective rear riser strap extending all the way between the waist belt and the respective leg strap, and does not include the seat panels. In such embodiments, the movement-permitting connector can be attached to the first end of the leg strap (or to one of the riser straps), and the leg straps each extend circumferentially all the way around the wearer's respective leg but still through the respective movement-permitting connector with its second end attached to the waist belt or another part of the safety harness (e.g., an upper portion at or above the wearer's waist).

In still other embodiments, the rear risers each include a seat panel, and the leg loops are not self-adjusting, with the respective leg straps attached to the two opposite corners/sides of the bottom of the seat panel by fixed attachment without the self-adjusting feature. In such embodiments, the leg straps do not include the movement-permitting connector and do no attach to the waist belt.

In yet still other embodiments, one of the support risers for each leg includes a seat panel, and the leg loops are self-adjusting, but the seat panel is included solely for proving a rigid elongated element between the leg loops and the waist belt for good operation of the self-adjusting leg loops (so upon tensioning of the tensioning riser, the riser cannot shorten and allow the leg loops to pull up into the wearer's crotch). In such embodiments, the seat panels can be provided by elongated strips or other pieces of rigid material (so they are not literally for sitting upon), and they can be positioned at the outer side, inner side, or front of the wearer's body when the harness is worn (so they are not literally at the rear).

In yet still other embodiments, the safety harness includes two risers for each leg but at different positions, for example inner and outer risers at the inside and outside of the wearer's legs, with the leg straps each still routed through the respective movement-permitting connector to form at least a portion of the respective leg loop and attach to the waist belt. In related embodiments, the safety harness includes one riser for each leg, with each having the respective movement-permitting connector attached to it and the fixed end of the respective leg strap attached to it so that the leg strap can be routed around the leg and through the connector, with its opposite/free end attached to the waist belt or another portion of the harness (e.g., an upper portion at or above the wearer's waist).

In other embodiments, the connectors are located at the wearer's inner thighs (instead of outer thighs), so the leg straps extend from the first end and connector in the opposite direction down, around, and back across the top of the wearer's legs. In such embodiments, the tensioning riser portions of the leg straps are adjacent and between the wearer's legs, and they can be connected or formed together as a single tensioning riser for a portion of their lengths.

In still other embodiments, the safety harness is a seat harness that includes the self-adjusting leg loops and includes shoulder, torso, or other straps but does not include a waist belt. The leg straps still route through the respective movement-permitting connector to form at least a portion of the respective leg loop, but their second ends attach to shoulder straps, torso straps, other straps, and/or another portion of the safety harness (e.g., an upper portion at or above the wearer's waist).

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the specific sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A safety harness for suspending a wearer in an elevated position by a safety tether, the safety harness comprising:
an upper portion adapted to be worn by the wearer and connectable to the safety tether; and
two leg loops connected to the harness upper portion, wherein each leg loop includes a leg strap and a movement-permitting connector, wherein the leg strap includes a first end, an opposite second end, and an intermediate portion therebetween, with the connector attached at the first end of the leg strap, the second end of the leg strap attached to the harness upper portion, and the intermediate portion of the leg strap movably engaged by the connecter to permit longitudinal movement of the leg strap relative to the connector, wherein the intermediate portion of the leg strap forms a leg-loop portion and a tensioning riser portion, with the leg-loop portion defined between the first end of the leg strap and a then-current engagement location of the intermediate portion where it engages the connector, with the tensioning riser portion defined between the second end of the leg strap and the then-current engagement location of the intermediate portion, and with the leg strap portion movable relative to the connector to shorten the leg loop portion in response to lengthening the tensioning riser, and vice versa, and, wherein in use the leg strap slides through the connector to loosen or tighten the leg loop in response to body movement of the wearer.

2. The safety harness of claim 1, wherein the upper portion includes a waist belt adapted to extend around the waist of the wearer, and wherein the second end of the leg strap attaches to the waist belt.

3. The safety harness of claim 2, wherein the upper portion further includes two shoulder straps adapted to extend over the wearer's shoulders and connected to the waist belt.

4. The safety harness of claim 1, wherein the leg loop portions of the leg straps each extend laterally around one respective leg of the wearer, and wherein the tensioning riser portions of the leg straps each extend upward from the connector and attach to the harness upper portion.

5. The safety harness of claim 1, wherein the leg loop portions of the leg straps each extend horizontally all the way around the respective leg at uniform drop distance below the waist and crotch of the wearer so the leg loops are not angled from the crotch to the waist of the wearer.

6. The safety harness of claim 1, wherein the two leg loops portions of the leg straps are each connected to the harness upper portion by one or more support risers.

7. The safety harness of claim 6, wherein the one or more support risers for each leg loop portion include a front support riser, a rear support riser or both.

8. The safety harness of claim 6, wherein at least one of the support risers for each leg loop includes a rigid seat panel.

9. The safety harness of claim 8, wherein the seat panels each include an elongated triangular rigid plate.

10. The safety harness of claim 8, wherein the rigid seat panels connected between the leg loops and the harness upper portion provide mechanical interference to restrain the leg loops from being pulled up into the crotch of the wearer during use.

11. The safety harness of claim 8, wherein the support riser including the seat panel is a rear support riser.

12. The safety harness of claim 6, wherein each leg strap includes two segments, with a first segment formed by a portion of the respective seat panel and with a second segment extending from the respective seat panel, wherein the first leg strap segment and a portion of the second leg strap segment define the respective leg loop portion.

13. The safety harness of claim 12, wherein the movement-permitting connector at the first end of the leg strap is also at the seat panel of the support riser.

14. A safety harness for suspending a wearer in an elevated position by a safety tether, the safety harness comprising:
a waist belt adapted to extend around the waist of the wearer and connectable to the safety tether;
two leg loops connected to the waist belt, wherein each leg loop includes a leg strap and a movement-permitting connector, wherein the leg strap includes a first end, an opposite second end, and an intermediate portion therebetween, with the connector attached at the first end of the leg strap, the second end of the leg strap attached to the waist belt, and the intermediate portion of the leg strap movably engaged by the connecter to permit longitudinal movement of the leg strap relative to the connector, wherein the intermediate portion of the leg strap forms a leg-loop portion and a tensioning riser portion, with the leg-loop portion defined between the first end of the leg strap and a then-current engagement location of the intermediate portion where it engages the connector, with the tensioning riser portion defined between the second end of the leg strap and the then-current engagement location of the intermediate portion, and with the leg strap portion movable relative to the connector to shorten the leg loop portion in response to lengthening the tensioning riser, and vice versa, and, wherein in use the leg strap slides through the connector to loosen or tighten the leg loop in response to body movement of the wearer; and
two support risers each connected between the waist belt and a respective one of the leg loops portions of the leg straps, wherein each support riser includes a rigid seat panel, wherein the rigid seat panels provide mechanical interference to restrain the leg loops from being pulled up into the crotch of the wearer during use.

15. The safety harness of claim 14, wherein the leg loop portions of the leg straps each extend laterally around one respective leg of the wearer, and wherein the tensioning riser portions of the leg straps each extend upward from the connector and attach to the waist belt.

16. The safety harness of claim 14, wherein the leg loop portions of the leg straps each extend horizontally all the way around the respective leg at uniform drop distance below the waist and crotch of the wearer so the leg loops are not angled from the crotch to the waist of the wearer.

17. The safety harness of claim 14, wherein the seat panels each include an elongated triangular rigid plate.

18. The safety harness of claim 14, wherein each leg strap includes two segments, with a first segment formed by a portion of the respective seat panel and with a second segment extending from the respective seat panel, wherein the first leg strap segment and a portion of the second leg strap segment define the respective leg loop portion, and wherein the movement-permitting connector at the first end of the leg strap is also to the seat panel.

19. The safety harness of claim 14, wherein the support riser including the seat panel is a rear support riser.

20. A safety harness for suspending a wearer in an elevated position by a safety tether, the safety harness comprising:
an upper portion adapted to be worn by the wearer and connectable to the safety tether;
two leg loops connected to the harness upper portion and formed by two leg straps, wherein the leg loop portions of the leg straps each extend horizontally all the way around the respective leg at uniform drop distance below the waist and crotch of the wearer so the leg loops are not angled from the crotch to the waist of the wearer; and
two support risers connected between the harness upper portion and the leg loops, wherein each support riser includes a rigid seat panel and forms one half of a seat for the wearer during use, wherein each rigid seat panel is curved to conform to the buttocks of the wearer, and wherein the rigid seat panels provide mechanical interference to restrain the leg loops from being pulled up into the crotch of the wearer during use.
